(19) United States
(12) Patent Application Publication
(10) Pub. No.: US 2008/0166036 A1
(43) Pub. Date: Jul. 10, 2008

(54) SYSTEM AND METHOD FOR ANALYZING TISSUE SLIDES FOR OBSERVABLE PATHOLOGIES

(75) Inventors: Kenneth J. Bloom, Laguna Niguel, CA (US); Jack A. Zeineh, Fullerton, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: CARL ZEISS MICROIMAGING AIS, INC., Aliso Viejo, CA (US)

(21) Appl. No.: 11/969,714

(22) Filed: Jan. 4, 2008

Related U.S. Application Data
(60) Provisional application No. 60/883,616, filed on Jan. 5, 2007.

(51) Int. Cl. G06K 9/00

(52) U.S. Cl. 382/133

(57) ABSTRACT

A system, device, and method for analyzing cellular specimen slides for observable pathologies, including presenting a first image of a first slide including a first portion of a cellular specimen, wherein the first portion is stained with a first stain, initiating an automated randomization sequence, wherein one or more regions of the first image are randomly selected and presented, and effecting analysis of the first image at each of the one or more regions to determine whether each of the one or more regions includes an area of interest.

### RELATED APPLICATION

The present application claims the benefit of U.S. Provisional Application No. 60/883,616, filed Jan. 5, 2007, which is incorporated herein in its entirety by reference.

### FIELD

The present invention relates generally to pathology. More particularly, the embodiments of the present invention relate to systems and methods for analyzing tissue slides for observable pathologies.

### BACKGROUND

Immunohistochemistry scoring of tissue sections microscopically often involves analyzing multiple slides. One slide can include a tissue sample stained with a hematoxyln and eosin (“H+E”) stain for identification of cancerous areas. Others of the multiple slides can be include corresponding portions of the same tissue sample, but stained with an antibody to provide immunostaining. Such antibodies can include, for example, estrogen receptor (“ER”), progesterone receptor (“PR”), HER-2/neu, and KI-67.

Generally, once a pathologist has selected a case to review, the pathologist analyzes and scores the slides and generates a report of the case analysis. Current computerized systems often do not enable flexibility or much deviation from a set protocol. For example, a pathologist may have to follow a protocol without the ability to change the order of steps or redo or modify steps of the protocol.

H+E stained slides are often analyzed by manually selecting fields and identifying which of the fields have cancerous cells. Such manual selection of fields, however, can be wrought with human-sourced field selection biases that adversely affect the efficiency and reproducibility of the slide scoring process.

Also, when reviewing slides stained with antibodies, pathologists often have their own particular order in which they review and analyze slides. While one pathologist might review the slides in one order, another might review the slides in a completely different order. Before analyzing the slides, each pathologist often begins by putting the slides or images thereof into the order in which they will be viewed. Such ordering can be time consuming and inefficient, especially when a pathologist must analyze hundreds of slides per day.

There is thus a need for improved systems and methods of analyzing tissue slides for observable pathologies.

### BRIEF SUMMARY

A method for analyzing cellular specimen slides for observable pathologies, the method including presenting a first image of a first slide including a first portion of a cellular specimen, wherein the first portion is stained with a first stain, initiating an automated randomization sequence, wherein one or more regions of the first image are randomly selected and presented, and effecting analysis of the first image at each of the one or more regions to determine whether each of the one or more regions includes an area of interest.

A program, on a computer-readable medium, for analyzing cellular specimen slides for observable pathologies. The program includes instructions for causing a system to capture a first image of a first portion of a cellular specimen on a first slide, wherein the first portion is stained with a first stain, initiate an automated randomization sequence, wherein one or more regions of the cellular specimen are randomly selected and presented, and analyze the first image at each of the one or more regions to determine whether each of the one or more regions includes an area of interest.

A method for analyzing cellular specimen slides for observable pathologies, the method including providing a plurality of slides, each including a portion of a cellular specimen, wherein each of the portions is stained, capturing an image of each of the stained portions, presenting the images in a predetermined order based upon cellular specimen type and a type of the stain.

A method for analyzing cellular specimen slides for observable pathologies, the method including identification of areas of interest including, presenting a first image of a first slide including a first portion of a cellular specimen, wherein the first portion is stained with a first stain, selecting and presenting one or more regions of the first portion, and effecting analysis of the first image at each of the one or more regions to determine whether each of the one or more regions includes an area of interest, and registration of the images of the slides including presenting a second image of a second slide including a second portion of the cellular specimen stained with a second stain and a third image of a third slide comprising a third portion of the cellular specimen stained with a third stain, wherein the second and third images are presented to a user in a predetermined order, and locating of corresponding areas of interest on the on the second and third images, the corresponding areas of interest substantially corresponding to the area of interest on the first image.

### BRIEF DESCRIPTION OF THE DRAWINGS

FIG. 1 is a flow diagram of a method of analyzing cellular specimen slides for observable pathologies, wherein phantom lines illustrate optional paths for a user and solid-lined arrows illustrate a standard or default path;

FIG. 2 is a flow diagram of a method of analyzing cellular specimen slides for observable pathologies according to a first embodiment;

FIG. 3 is a flow diagram of a method of analyzing cellular specimen slides for observable pathologies according to a second embodiment;

FIG. 4 is a flow diagram of a method of analyzing cellular specimen slides for observable pathologies according to a third embodiment;

FIG. 5 is a flow diagram of a method of analyzing cellular specimen slides for observable pathologies according to a fourth embodiment;

FIG. 6 is a flow diagram of a case selection step of a method of analyzing cellular specimen slides for observable pathologies according to an embodiment;

FIG. 7 is a flow diagram of a cancer identification step of a method of analyzing cellular specimen slides for observable pathologies according to a first embodiment;

FIG. 8 is a flow diagram of a cancer identification step of a method of analyzing cellular specimen slides for observable pathologies according to a second embodiment;

FIG. 9 is a flow diagram of a cancer identification step of a method of analyzing cellular specimen slides for observable pathologies according to a third embodiment;

FIG. 10 is a flow diagram of a registration step of a method of analyzing cellular specimen slides for observable pathologies according to a first embodiment; and

FIG. 11 is a flow diagram of a registration step of a method of analyzing cellular specimen slides for observable pathologies according to a second embodiment.

### DETAILED DESCRIPTION OF THE DRAWINGS

The embodiments of the present disclosure provide a flexible, workflow tool for improving the efficiency and reproducibility of the slide scoring process. The embodiments enable flexible slide examination, registration, scoring, and reporting. The processes can be executed in varying orders, thereby providing maximum flexibility to the pathologist.

Further, the embodiments of the present disclosure enable automated field selection during slide examination. Manual field selection by a pathologist can be wrought with human-sourced field selection biases. By implementing random field selection, with manual pathologist or automatic confirmation, the bias previously present is greatly reduced or eliminated from the scoring process.

Also, the embodiments of the present disclosure enable a user to set up a user profile for slide sorting, further improving the efficiency and reproducibility of the slide scoring process. For example, a pathologist can set up a user profile for doing analysis of, for example, breast tissue, cervical tissue, uterine tissue, or the like. If the user desires sorting slides stained with antibodies in the order of 1) PR, 2) ER, 3) HER-2/neu, and 4) KI-67, the system can sort the slides according to a user profile and present the slides in that order.

Examples of systems and devices that can be used with the embodiments herein are described in U.S. Pat. Nos. 6,151,405, 6,418,236, 6,553,135, 6,993,169, and 7,212,660, all of which are incorporated herein by reference in their entirety. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

While the systems and methods of pathology slide analysis are amenable to various modifications and alternative forms, specifics thereof have been shown by way of example in the drawings and below description. It should be understood, however, that the intention is not to limit the devices and methods of pathology slide analysis to the particular embodiments described. On the contrary, the intention is to cover all modifications, equivalents, and alternatives falling within the spirit and scope of the devices and methods of pathological slide analysis as defined by the appended claims.

Slides viewed can be prepared in several ways. Example protocols for slide preparation, as well as description of example stains, are discussed below.

### Nuclear Stains, Intercalating Dyes and Counterstains

The term “nuclear stain” refers to a cytochemical stain that preferentially stains the nuclei of eukaryotic cells. Some nuclear stains are intercalating dyes, wherein the compound inserts itself between adjacent nucleotides of a nucleic acid providing a detectable color.

One of the most commonly used nuclear stains is hematoxylin, which is often used in combination with various metallic salts (mordants). Hematoxylin stains are used for different staining purposes, and have a variety of colors, depending on the mordant used. Aluminum salts are purple to blue, depending on pH. Iron salts are blue-black. Chromium salts are blue-black. Copper salts are blue-green to purple. Nickel salts are various shades of violet. Tin salts are red. Lead salts are dark brown. Osmium salts are greenish brown. Other nuclear stains include Giemsa, methyl green (binding to AT-rich DNA regions), and Nuclear Fast-Red.

Fluorescent stains include Hoechst 33342; Hoechst 33258 (Calbiochem), a bisbenzimide DNA intercalator exciting in the near UV wavelengths (350 nm) and emitting in the blue region (450 nm); thiazole orange, a fluorogenic stain for DNA exciting in the blue region (515 nm) and emiting in the green region (530 nm) of the visible spectrum; 4′,6-diamidino-2-phenylindole (DAPI), visualizing nuclear DNA in both living and fixed cells and used to determine the number of nuclei and to assess gross cell morphology of cells; ethidium bromide, an intercalating agent commonly used as a nucleic acid stain, fluorescing with a red-orange color when exposed to UV light; propidium iodide, an intercalating agent and a fluorescent intercalating agent used to stain DNA to differentiate necrotic, apoptotic and normal cells; TOTO; YOYO-1; and SYTOX.

Blue or Green stains are also contemplated. Several dyes either bind GC-rich or AT-rich chromosomal regions preferentially or show differences in fluorescence intensity upon binding those regions, yielding fluorescent banding patterns. By way of example, 7-aminoactinomycin D binds selectively to GC-rich DNA regions and 9-amino-6-chloro-2-methoxyacridine fluoresces with greatest intensity in AT-rich DNA regions. Acridine homodimer fluoresces preferentially when bound to AT-rich DNA regions.

The term “counterstain,” when used in combination with nuclear stains, refers to cytochemical stains that bind to a region of a eukaryotic cell other than the nucleus. One of the most common counterstains is eosin, which stains eukaryotic cell cytoplasm to varying shades of pink. Other counterstains are specific for a particular organelle or a protein in a cell. For example, Kleihauer-Betke cytochemical stain is specific for hemoglobin F, a hemoglobin type preferentially expressed in fetal cells, therefore a specific marker of fetal red blood cells. The term “coordinate” or “address” is used to mean a particular location on a slide or sample. The coordinate or address can be identified by any number of means including, for example, X-Y coordinates, r-P coordinates, and others recognized by those skilled in the art.

In one embodiment, the slides are stained with hematoxylinleosin (H+E) and one or several parallel slides containing adjacent sections are stained for one or several specific markers. The results of the H+E staining provide cells with nuclei stained blue-black, cytoplasm stained varying shades of pink; muscle fibers stained deep pinky red; fibrin stained deep pink; and red blood cells stained orange-red. For example, hematoxylin/eosin (H+E) slides are prepared with a standard H+E protocol. Standard solutions include the following: (1) Gills hematoxylin (hematoxylin 6.0 g; aluminum sulphate 4.2 g; citric acid 1.4 g; sodium iodate 0.6 g; ethylene glycol 269 ml; distilled water 680 ml); (2) eosin (eosin yellowish 1.0 g; distilled water 100 ml); (3) lithium carbonate 11% (lithium carbonate 1 g; distilled water 100 g); (4) acid alcohol 1% 70% (alcohol 99 ml conc.; hydrochloric acid 1 ml); and (5) Scott's tap water. In a beaker containing 1 L distilled water, add 20 g sodium bicarbonate and 3.5 g magnesium sulphate. The staining procedure is to: (1) bring the tissue or cell sections to water; (2) place sections in hematoxylin for 5 minutes; (3) wash in tap water; (4) ‘blue’ the sections in lithium carbonate or Scott's tap water; (5) wash in tap water; (6) place sections in 1% acid alcohol for a few seconds; (7) wash in tap water; (8) place sections in eosin for 5 min; (9) wash in tap water; and (10) dehydrate with graded alcohol solution.

### Markers

A specific marker is a molecule or a group of molecules, present in only a subset of the components of a biological specimen and therefore identifying specific components having the marker. Specific markers are frequently defined as antigens recognized by monoclonal or polyclonal antibodies, detected by immunohistochemistry. Exemplary and nonlimiting antibodies include estrogen receptor (“ER”), progesterone receptor (“PR”), and HER-2/neu, which is a member of the epidermal growth factor receptor family. Another group of specific markers include nucleic acid probes. These markers are usually detected by in situ hybridization. A third group of specific markers can be defined by their enzymatic activity and can be detected by histochemistry. A fourth group of specific markers can be stained directly, histochemically, using a specific dye. A fifth group of specific markers can be defined as being receptors binding specifically to one or several ligands. A specific ligand is itself used for the detection of the receptor-ligand complex, using a detection method involving histochemistry, immunohistochemistry, or in situ hybridization.

### Immunohistochemical and In Situ Hybridization Techniques

Immunohistochemical techniques as used herein encompass using reagents for detecting cell specific markers, such reagents including, for example, antibodies and nucleic acid probes. Antibodies, including monoclonal antibodies, polyclonal antibodies and fragments thereof, are often used to identify proteins or polypeptides of interest in a sample. A number of techniques are utilized to label objects of interest according to immunohistochemical techniques. Such techniques are discussed in Current Protocols in Molecular Biology, Unit 14 et seq., eds. Ausubel, et al., John Wiley & Sons, 1995, hereby incorporated by reference. The following procedure is exemplary of immunohistochemical staining using an antibody for the HER2 protein. HER2 overexpression is recognized as a specific marker in a high percentage of breast cancer carcinomas. The following protocol stains a paraffin embedded tissue section.

The section is deparaffinized using two baths of xylene and rehydrated through graded alcohols baths and finally in deionized water. The section is then incubated with an Antigen Retrieval Buffer, containing Citrate, for 40 minutes at 95.degrees Centigrade. The slide is then cooled at room temperature for 20 minutes in the same buffer, then rinsed in deionized water. The area surrounding the tissue section is carefully dried and a hydrophobic delimiting pen is used to draw a line around the specimen, on the glass slide. A peroxidase blocking solution is added on the section and incubated 5 minutes at room temperature. After being washed twice with wash buffer (a balanced salt solution), the tissue section is incubated 30 minutes at room temperature, with the primary antibody recognizing the HER2 protein.

After 3 washes with the wash buffer, the tissue section is incubated with the peroxidase-conjugated secondary antibody. The secondary antibody will recognize specifically the primary antibody. The slide is then washed 3× with the wash buffer. Then the tissue section is incubated in presence of DAB and hydrogen peroxide for 10 minutes, before being washed with water.

The tissue section is counterstained in hematoxylin for 2 minutes and rinsed again with water. The slide is mounted with a cover-slip using an aqueous mounting medium. Immunohistochemical localization of cellular molecules uses the ability of antibodies to bind specific antigens, for example proteins of interest such as onco-proteins and enzymes, with high affinity. These antibodies can be used to localize antigens to subcellular compartments or individual cells within a tissue.

In situ hybridization techniques include the use of specifically labeled nucleic acid probes, which bind to cellular RNA or DNA in individual cells or tissue sections. Suitable nucleic acid probes can be prepared using standard molecular biology techniques including subcloning, plasmid preparation, and radiolabeling, or non-radioactive labeling of the nucleic acid probe.

In situ hybridization is often performed on either paraffin or frozen sections. Such techniques often include fine sectioning of tissues to provide samples that are only a single to a few cell layers thick. For example paraffin blocks containing a tissue sample are cut, e.g., using a microtome, into thin, approximately 8 micrometer tissue sections, which are subsequently mounted on subbed slides to be further processed for in situ hybridization. Alternatively, methacrylate can be used for sectioning. Cryosectioning techniques are also suitable for immunohistochemistry and enzyme histochemistry.

Immunofluorescent labeling of a tissue section often uses a sandwich assay or a primary antibody-secondary antibody-fluorochrome conjugate. Slides containing a tissue section of interest are washed in phosphate buffered saline and then exposed to a primary antibody which will bind to the protein object of interest. Subsequently the slides are washed and exposed to the secondary antibody which binds to the first or primary antibody. The slide is washed, then developed. Other techniques known to the art of immunohistochemical staining and in situ hybridization are adaptable for use in immunohistochemical reconstruction as disclosed herein.

Often sequential slides from a biopsied tissue sample are desired, e.g., in the context of the registration protocol of this disclosure. In these cases, sequential portions of the tissue sample are obtained, e.g., with a microtome. The samples are then fixed to slides and prepared for viewing, care being taken to preserve the order of the obtained samples.

### System Flow

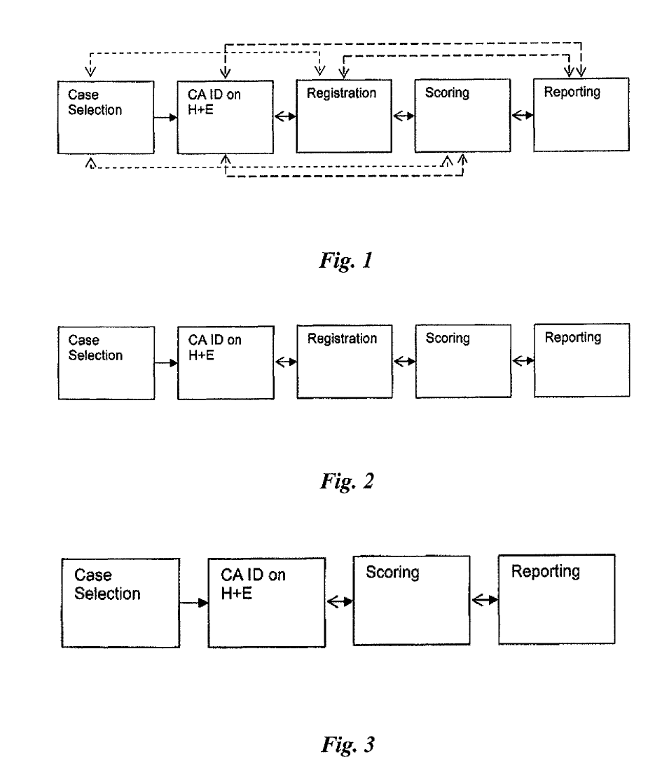

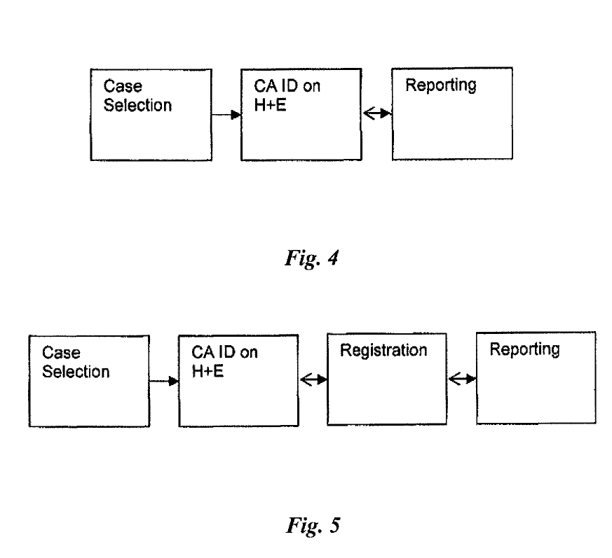

Referring to FIGS. 1-5, a number of functional steps are provided that can interact with each other in a flexible way. Examples of functional steps that can be linked together are:

a. Case Selection—pathologist selection of a case of interest to review;

b. Cancer Identification on H+E (“CA ID on H+E”)—pathologist review of the H+E stained slide and identification of cancerous areas;

c. Registration—alignment of tissues on different slides so that a particular area of interest on one slide (e.g., H+E stained slide) can be located via coordinate transformation or image transformation) on another slide (e.g., slides stained with antibodies);

d. Scoring—quantification of the amount of stain and transformation to a standardized scoring system; and

e. Reporting—generating a report of the case analysis, which can include images of regions of interest along with associated scoring information.

The first step can be Case Selection. From there the user can view the slide for cancer identification and then proceed to registration or the user can elect to bypass registration and go to scoring or go directly to reporting. Referring again to FIG. 1, broken-lined arrows between functional boxes illustrate optional traversal paths for the user with solid-lined arrows illustrating a standard suggested or default path as can be presented to the user by a ‘wizard’ or similar computer guided path.

### Case Selection

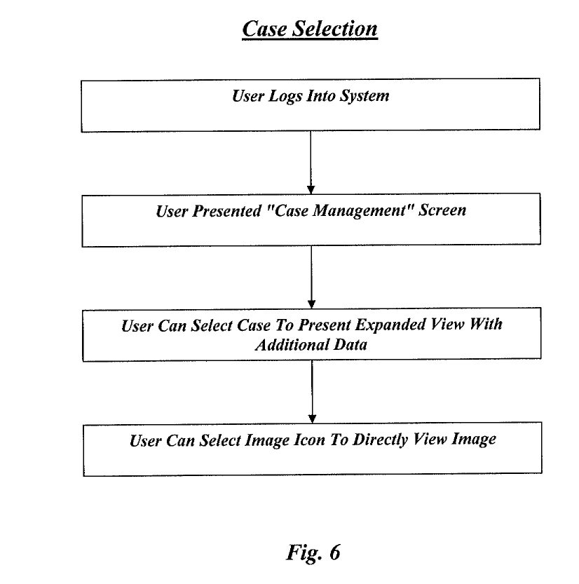

Referring to FIG. 6, in an embodiment, case selection can comprise the following steps:

1. User Logs into the system;

2. User is presented ‘case management’ screen which can include:
a. a list of all cases (pending and completed);
b. a descriptor of which cases have images associated with them;
c. patient name; and
d. tests ordered;

3. User can select case to present expanded view which presents additional data about the case not presented in the initial list view;

4. User can select image icon to go directly to image viewing for that case.

### Cancer Identification on H+E

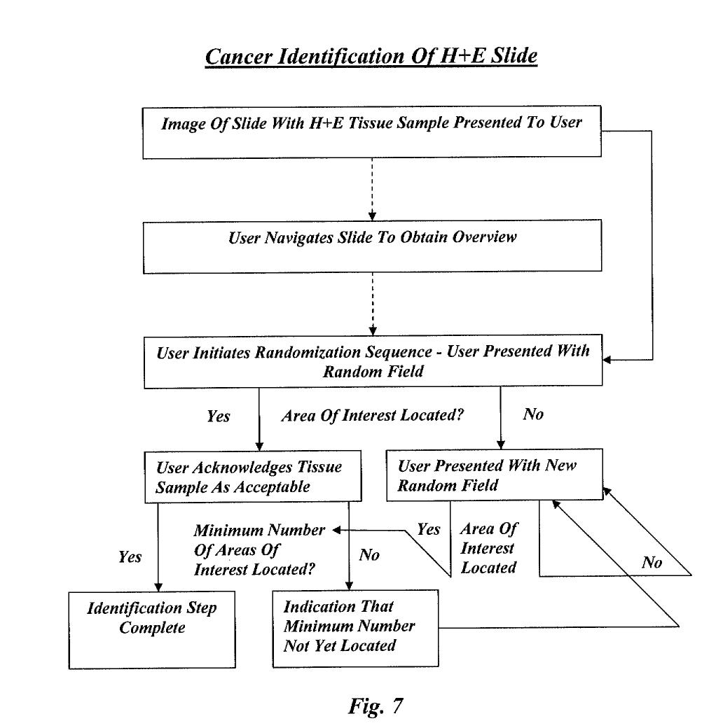

Referring to FIG. 7, an example flow of how cancer identification on H+E with random field selection by the user would occur would include the following steps:

1. First image that is presented to the user is the H+E image for cancerous area identification

2. User optionally navigates the slide to obtain an overview

3. User initiates randomization sequence
a. If an area of interest (cancerous) is located, user acknowledges as acceptable
b. If an area of interest is not cancerous, user is presented a new random field
c. Randomization sequence should not end until a predetermined minimum number of fields are selected—soft error message can be presented to user notifying them of this.

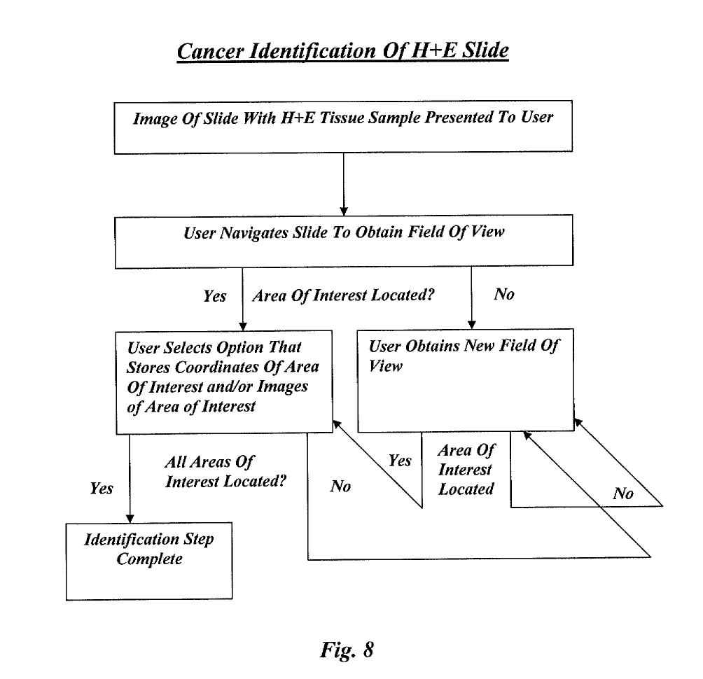

In an embodiment, referring to FIG. 8, the pathologist can elect not to use random field selection and can rather simply manually choose fields. The steps in such a process would go as follows:

1. H+E image is presented to the user;

2. User navigates the slide locating images of interest;

3. When area of interest (e.g., cancerous) is located, user selects an option that stores the coordinates and/or an image of the region of interest;

4. User continues locating regions of interest until all regions of interest have been identified.

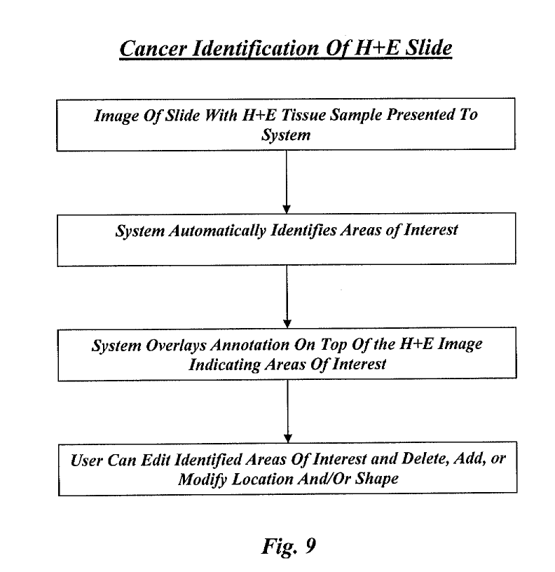

As another alternative, referring to FIG. 9, the user can elect to have automated cancerous area detection be performed by the system. The flow of such a process could proceed as follows:

1. Cancerous areas are automatically identified by the system;

2. System overlays an annotation on top of the H+E image indicating areas suspicious for cancer; and

3. User can edit the identified regions, deleting, adding, and changing location or shape as needed

### Registration

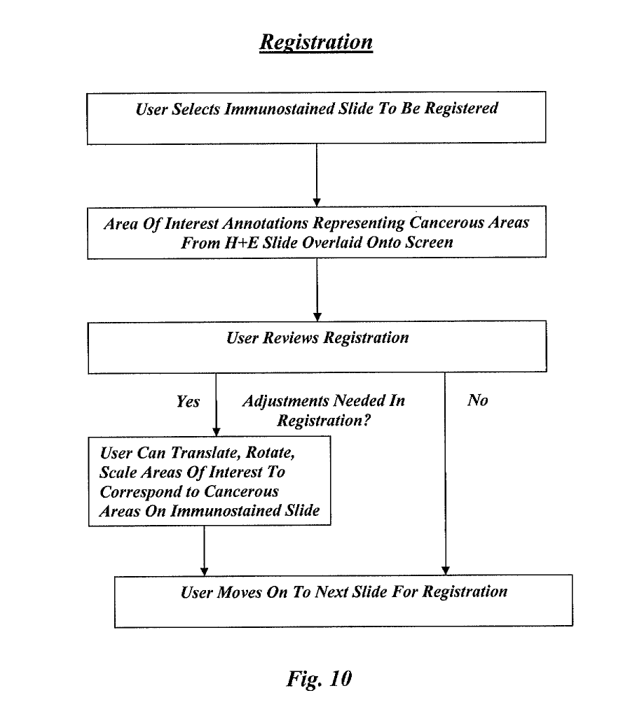

Referring to FIG. 10, an example process flow for registration can be the following for a manual registration process:

1. User selects an immunostained slide to be registered;

2. Region of interest annotations representing cancerous areas from the H+E are overlaid onto a screen; and

3. User reviews registration:
a. If adjustments are needed, the user is able to translate and rotate the regions of interest in order for the regions to correspond to cancerous areas;
b. User can switch back and forth between H+E and immunostained slide to compare regions of interest. This switch can done several ways;
   i. Single view toggle: A toggle changing the image being displayed on the view screen. In this case only one slide can be displayed at a time but the user can rapidly switch the slide being displayed;
   ii. Side by side viewing: In this case, both slides are presented at the same time, each in different windows. Each slide can be navigated independently or synchronously where movement in one is duplicated in the other.
   iii. Transparency toggle: In this case, the images are overlaid on top of each other with one slide having a translucent transparency factor. The user can switch back and forth as to which is the translucent slide.

The user can switch back and forth between any of the foregoing modes of viewing. For example, if the user is in transparency toggle mode, the user can switch back to single view toggle.

4. User selects next slide, steps 2-3 are repeated until all slides are registered or user determines no additional registration is desired.

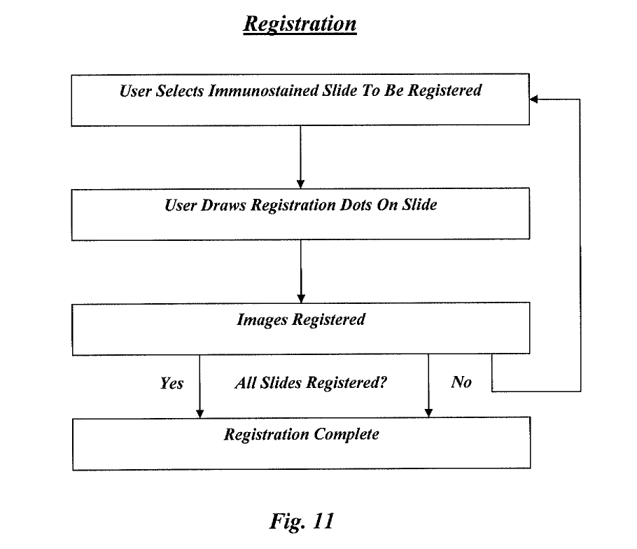

In an embodiment, referring to FIG. 11, the user can do semi-automated registration involving user-specified anchors.

1. User selects H+E slide;

2. User draws registration dots. In an embodiment, the user draws at least three dots. If the user draws less than three dots, the system can provide a notice that less than ideal registration can occur. Also, if the dots are collinear a similar notice can be presented to the user;

3. User selects an immunostained slide to be registered;

4. User draws registration dots on the immuntostained slide;

5. Images are then registered; however, user can move registration dots if alignment is not optimal. User can elect to employ the previously described manual registration for realignment and verification, the difference between standard manual alignment being that the images have been aligned based on the registration dots and that there are visible registration dots;

6. User selects next slide, steps 3-5 are repeated until all slides are registered or user determines no additional registration is desired.

In a further embodiment, the user can elect to have the system conduct automated registration. In this embodiment, the system automatically registers the slides. The automated registration can be conducted so that the computations are completed before the user requests automated registration. For example, the system can automatically register slides when the user selects a case or as soon as all images for a case are ready for review. Confirmation of the automated registration can be done by manual registration mode.

In yet another embodiment, the user can elect to do no registration.

### Scoring

An example process flow for scoring can be the following:

1. User selects ‘score’;

2. Summary results are displayed to the user. The summary results can be displayed in a window. This window can be accessed through a tab list if window space is limited or, in the case of more available screen space such as in dual screens, this window can be one of many windows in a second screen. The summary results can contain image thumbnails of the regions being scored as well as raw stain intensity score in addition to binned standardized score

3. User can override each score;

4. If thumbnails for the regions that are scored are displayed to the user, the user can be given the option of being able to view the corresponding area on the whole slide by selecting the thumbnail. Selecting the thumbnail would then set correct position and magnification on a whole slide viewing screen such as that used for the cancer identification step;

5. User can be presented the option of viewing what parts of the image the system utilized to generate a stain score. For example, the system can display which areas it determined did not contain an immunostain as well as displaying areas that, while they can or can not have contained immunostain, were not morphologically correct areas to score (e.g., the area was stromal instead of epithileal tissue);

6. User can be presented with options to edit how the system generates stain scores. For example the user can elect to exclude areas that were scored using image annotation tools such as circles, polygons or freehand drawings or by selecting the area to be scored if the system indexes areas so that they are separately selectable. User can also designate areas that were not scored through image annotation tools.

In another embodiment, the user can elect to generate the scores manually without direct computer assistance.

Examples of manual or automated scoring processes that can be used are described in U.S. Pat. Nos. 7,177,454, 6,697,509, and 6,546,123, all of which are incorporated herein by reference in their entirety. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

### Reporting

1. User is presented the option of having both a live results window and a reporting window.

2. The live results window may have multiple fields. The fields that are available may be configured per the type of application as well as user and/or site preference. The configurable elements of each field may include name, data type (text, integer number, floating point number, etc), font, and formatting options. This live results window receives real time or near real time updates from the automated scoring system. The live results window may also include case information that was entered or extracted from an external information system The live results window can also include institution specific information such as pathology group, reference information to assist the recipient in understanding the meaning of the scores, and image thumbnails of the scored regions.

3. The live results window can be edited by the user. Such information as scoring can be overridden by the user. Other fields may not be editable as determined by the configuration options utilized. As an example, the patient name may be configured as non-editable.

4. The reporting window shows the user what the actual printed report will look like. The reporting window utilizes all or a subset of information from the live results window together with other data that may not be in the results window, such as reference data. The reporting window then formats this data based upon a predetermined template such as a Microsoft Word template to generate the report which may be in such format as PDF. A useful feature of this reporting window is that as new data is available, such as from the live results window, the report is updated.

5. Another useful feature of the system is that live results data and reporting data may be stored in a ‘history’ database as the user is performing their work. This ‘history’ database may also include registration information sufficient to recreate the then current registration the user has configured, selected region information sufficient to recreate the then current regions that are selected, as well other session specific data. This ‘history’ database allows the user to interrupt their work and come back at a later time without having to start over. This ‘history’ database also provides a potentially useful research tool for providing analysis of pathologist workflow—i.e what order they do things and how much time they spend on a particular task.

6. Upon completion of review, the user may select the ‘sign out’ or ‘commit’ feature that allows the data in the live results window as well as the reporting window to be committed to a database or other persistent storage medium as complete. This live results data and the report may then be retrieved at a later date.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. For purposes of the present disclosure, incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

What is claimed is:

1. A method for analyzing cellular specimen slides for observable pathologies, said method comprising:
presenting a first image of a first slide comprising a first portion of a cellular specimen, wherein said first portion is stained with a first stain;
initiating an automated randomization sequence, wherein one or more regions of said first image are randomly selected and presented; and
effecting analysis of said first image at each of said one or more regions to determine whether each of said one or more regions comprises an area of interest.

2. The method of claim 1, wherein said first stain comprises a hematoxyln and eosin (“H+E”) stain and wherein said area of interest comprises a cancerous area.

3. The method of claim 1, further comprising:
providing a second image of a second slide comprising a second portion of said cellular specimen substantially corresponding to said first portion, wherein said second portion is stained with an immunostain; and
registering said first and second images such that said area of interest located on said first image can be located on said second image.

4. The method of claim 3, wherein said first image is marked at said area of interest, and wherein said step of registering comprising overlaying said annotated first image o relative to said second image.

5. The method of claim 3, wherein said registering further comprises adjusting said second image such that said area of interest located on said first image is substantially in alignment with a corresponding area of interest on said second image.

6. The method of claim 3, further comprising determining whether a minimum number of areas of interest are located on said first slide.

7. The method of claim 6, wherein said minimum number of areas of interest is predetermined based upon said immunostain.

8. The method of claim 3, wherein said steps of initiating and analyzing are repeated until a minimum number of areas of interest are located on said first slide.

9. The method of claim 1, further comprising scoring said slides.

10. A computer-readable medium having recorded therein indicia for performing the steps of:
capture a first image of a first portion of a cellular specimen on a first slide, wherein said first portion is stained with a first stain;
initiate an automated randomization sequence, wherein one or more regions of said cellular specimen are randomly selected and presented; and
analyze said first image at each of said one or more regions to determine whether each of said one or more regions comprises an area of interest.

11. The computer-readable medium of claim 10, further comprising instructions for causing said system to:
capture a second image of a second portion of said cellular specimen on a second slide, said second portion substantially corresponding to said first portion, wherein said second portion is stained with an immunostain; and
register said first and second images, such that said area of interest located on said first image can be located on said second image.

12. The computer-readable medium of claim 11, further comprising instructions for causing said system to:
determine whether a minimum number of areas of interest are located on said first slide.

13. The computer-readable medium of claim 11, further comprising instructions for causing said system to:
repeat steps of initiating and analyzing until a minimum number of areas of interest are located on said first image.

14. The computer-readable medium of claim 11, further comprising instructions for causing said system to score said slides.

15. A method for analyzing cellular specimen slides for observable pathologies, said method comprising:
providing a plurality of slides, each comprising a portion of a cellular specimen, wherein each of said portions is stained with a stain;
capturing an image of each of said stained portions;
presenting said images in a predetermined order based upon cellular specimen type and a type of said stain.

16. The method of claim 15, wherein said predetermined order is selected by a user.

17. The method of claim 15, wherein said stain is selected from the group consisting of: hematoxyln and eosin (“H+E”), ER, PR, HER-2/neu, KI-67, and any combinations thereof.

18. A method for analyzing cellular specimen slides for observable pathologies, said method comprising:
identification of areas of interest comprising:
presenting a first image of a first slide comprising a first portion of a cellular specimen, wherein said first portion is stained with a first stain,
selecting and presenting one or more regions of said first portion, and
effecting analysis of said first image at each of said one or more regions to determine whether each of said one or more regions comprises an area of interest; and
registration of said images of said slides comprising:
presenting a second image of a second slide comprising a second portion of said cellular specimen stained with a second stain and a third image of a third slide comprising a third portion of said cellular specimen stained with a third stain, wherein said second and third images are presented to a user in a predetermined order, and
locating of corresponding areas of interest on said on said second and third images, said corresponding areas of interest substantially corresponding to said area of interest on said first image.

19. The method of claim 18, further comprising scoring said slides and reporting results of said scoring.

20. The method of claim 19, wherein said steps of identification, registration, scoring, and reporting can be performed in any order.
